(19) United States
(12) Patent Application Publication
(10) Pub. No.: US 2019/0081538 A1
(43) Pub. Date: Mar. 14, 2019

(54) METHODS AND APPARATUS TO MITIGATE ELECTRICAL VOLTAGE ON A ROTATING SHAFT

(71) Applicant: Illinois Tool Works Inc., Glenview, IL (US)

(72) Inventors: Richard Nye, Poland, ME (US); Matthew Roman, Winthrop, ME (US)

(21) Appl. No.: 16/128,092

(22) Filed: Sep. 11, 2018

Related U.S. Application Data
(60) Provisional application No. 62/556,754, filed on Sep. 11, 2017.
(60) Provisional application No. 62/713,965, filed on Aug. 2, 2018.

(51) Int. Cl. H02K 11/026; H02K 7/08

(52) U.S. Cl. CPC H02K 11/026; H02K 7/003; H02K 7/08

(57) ABSTRACT

Methods and apparatus to mitigate electrical voltage on a rotating shaft are disclosed. An example grounding brush system mitigates electric current in a rotating shaft, the grounding brush system comprising: a brush assembly configured to be disposed proximate a motor shaft, the brush assembly having conductive filaments configured to be in electrical continuity with the motor shaft when the brush assembly is disposed proximate the motor shaft; and a conductive coating comprising a base liquid and conductive particles, in which the conductive coating coats at least respective portions of the conductive filaments so as to provide an electrical path between the conductive filaments and the motor shaft.

### RELATED APPLICATIONS

This patent claims priority to U.S. Provisional Patent Application Ser. No. 62/713,965, filed Aug. 2, 2018, entitled “METHODS AND APPARATUS TO MITIGATE ELECTRICAL VOLTAGE ON A ROTATING SHAFT,” and to U.S. Provisional Patent Application Ser. No. 62/556,754, filed Sep. 11, 2017, entitled “METHODS AND APPARATUS TO MITIGATE ELECTRICAL VOLTAGE ON A ROTATING SHAFT.” The entireties of U.S. Provisional Patent Application Ser. No. 62/713,965 and U.S. Provisional Patent Application Ser. No. 62/556,754 are incorporated herein by reference.

### BACKGROUND

This disclosure relates generally to electric motor protection and, more particularly, to methods and apparatus to mitigate electrical voltage on a rotating shaft.

### SUMMARY

Methods and apparatus to mitigate electrical voltage on a rotating shaft are disclosed, substantially as illustrated by and described in connection with at least one of the figures, as set forth more completely in the claims.

### BRIEF DESCRIPTION OF THE DRAWINGS

FIG. 1 is a perspective view of a motor having an example grounding brush system in accordance with the present disclosure.

FIG. 2 is a perspective view of an example shaft collar that may be used in the grounding brush system of FIG. 1.

FIG. 3A is a cross-sectional view of the motor and grounding brush system of FIG. 1.

FIG. 3B illustrates another example grounding system including a coating applied between the shaft and a grounding surface in sliding contact with the shaft.

FIG. 4 is a perspective view of the grounding brush of FIG. 3A.

FIG. 5 is a block diagram of an example fan array system including the grounding brush system of FIGS. 1-4.

FIG. 6 is a graph illustrating the performance of the example brush grounding systems compared with a conventional shaft voltage mitigation system.

The figures are not necessarily to scale. Where appropriate, similar or identical reference numbers are used to refer to similar or identical components.

### DETAILED DESCRIPTION

Induced Shaft electrical voltage is experienced in electric motors, and commonly in three-phase motors driven by variable speed drives. Variable speed drives utilize pulse width modulation (PWM) technology to vary the speed of AC motors, thereby allowing use of less-expensive AC motors in applications where more expensive DC motors had been used previously. A drawback to the use of AC motors with variable speed drives is that higher common mode voltage (CMV) is generated by the variable speed drive, which increases shaft induced currents.

Voltage on the motor shaft causes current flow through the shaft bearings to the motor frame and then to ground. While the motor is running, the bearings become more resistive to current flow, causing a buildup of charge on the shaft surfaces. Over a short period of time, the CMV causes electrical charges to build to a high level. As the electrical charges pass the threshold of the least electrically resistive path, sometimes through the ball bearings on the shaft, an instantaneous burst or discharge of electrical energy passes along the path. The discharge can cause electric discharge machining (EDM) along the path, which can damage the surfaces of the bearing races and the balls in the bearing if the least resistive path is through the bearings. The electrical energy burst creates fusion craters, and particulate from the crater formation remains inside sealed bearing. Both the fusion crater and the particulate material in the bearing act to disturb the free rotation of the bearing, which can lead to mechanical damage and premature bearing failure.

A number of mitigation technologies have been used in attempts to overcome this problem. Conventional techniques include using conductive bearing grease, insulating the bearings, and using copper/phosphorus brushes and a Faraday shield. Another conventional technique is to ground the shaft using spring-loaded copper brushes that provide a continuous flow of current to ground. However, copper brushes can wear out rapidly, requiring frequent, periodic service and replacement.

Motor shafts are subject to corrosion and rust, which interrupts the operation of conventional shaft grounding devices. Conventional shaft grounding devices tend to wear out quickly relative to the life of the motor. Conventional shaft grounding devices are susceptible to shaft corrosion, which can hamper the effectiveness of shaft grounding rings by interrupting the discharge path from the shaft to the ground. Corrosion build-up on the shaft and other barriers between the brushes and the shaft reduce the current flow and cause a burst of electrical energy across the brush and shaft, and/or across the motor bearings or across the gears or bearings or the like in attached equipment driven by the motor. Spring-loaded brushes also tend to vibrate due to alternating frictional relationships between the brush and the shaft surface. Vibration of the brushes, from whatever cause, can result in undesirable sparking and/or increased current flow through bearings and/or downstream equipment.

Other conventional methods include using mercury rotary couplings which, in addition to containing mercury, corrode at the contacts in the presence of high current and/or rapidly changing voltages, which leads to conductivity degradation over time and/or, in extreme cases, release of mercury. Mercury rotary couplings also require expensive and potentially unreliable seal mechanisms and require a narrow range of usable temperatures.

Impedance of conventional microfiber brushes is generally low enough for bearing protection, but the make/break nature of the signal, and the overall conductivity, lead to higher than ideal interference from connected equipment in certain environments (e.g., near AM bandwidth ratio receivers) and/or cause more electrical noise than is acceptable for data transmission applications. In some particularly stringent applications, such as but not limited to electric vehicles, military communications, and the like, the allowable degree of wear products or loose contaminates during installation of conventional microfiber brush techniques for current mitigation is difficult to achieve. Other conventional techniques include using carbon block, copper wire, or other conductive materials for brush. These other conventional conductive brushes suffer from unacceptable moderate term reliability and long term reliability (e.g., required service intervals are too short for some industries). Conventional conductive brushes generate significant dust which is discharged into the surrounding environment. In some applications, the inherent, constant wear particulates released by the conductive brushes are objectionable. High frequency impedance is too high for many applications requiring high frequency conductivity. The power required to overcome the resistance to mechanical motion is higher for conventional conductive brushes than is ideal for some applications.

Disclosed example grounding brush systems mitigate electric current in a rotating shaft, and include: a brush assembly configured to be disposed proximate a motor shaft, the brush assembly having conductive filaments configured to be in electrical continuity with the motor shaft when the brush assembly is disposed proximate the motor shaft; and a conductive coating comprising a base liquid and conductive particles, in which the conductive coating coats at least respective portions of the conductive filaments so as to provide an electrical path between the conductive filaments and the motor shaft.

Some example grounding brush systems further include a collar mounted to the motor shaft, in which the conductive filaments are in electrical contact with the motor shaft via the collar. In some examples, the collar is coated with the conductive coating at least at areas of contact between the collar and the conductive filaments.

In some examples, the motor shaft is coated with the conductive coating at least at areas of contact between the motor shaft and the conductive filaments. In some example grounding brush systems, the conductive particles comprise at least one of a powdered metal or carbon. In some examples, the base liquid comprises an oil. In some examples, the conductive filaments comprise at least one of carbon fiber, nickel, stainless steel, or a conductive plastic. In some examples, the conductive filaments are configured to be in electrical continuity with the motor shaft by at least one of: direct contact with the motor shaft, via a shaft collar, via a shaft extension, via a shaft stub, or via a gearbox shaft.

In some example grounding brush systems, the brush assembly is configured to be mounted on the motor shaft, and the conductive filaments are configured to extend radially outward from the motor shaft. In some examples, the base liquid comprises a phenyl ether polymer-derived oil. In some examples, the conductive coating is configured to be distributed to at least a portion of the conductive filaments by rotation of the motor shaft. In some example grounding brush systems, the brush assembly is configured to be coupled to an electrical ground to provide an electrical path between the motor shaft and an electrical ground.

In some examples, the brush assembly is configured to be mounted around the motor shaft, and the conductive filaments are configured to extend radially toward the motor shaft. In some example grounding brush systems, the brush assembly is configured to be mounted proximate the motor shaft, and the conductive filaments are configured to extend axially toward the motor shaft. In some examples, the conductive filaments and the conductive coating are configured to prevent failure due to excess current erosion of any bearings in electrical continuity with the motor shaft for at least the L-10 life of the bearings. In some examples, the conductive filaments and the conductive coating are configured to prevent failure due to current leakage erosion of any bearings in electrical continuity with the motor shaft for at least the L-10 life of the bearings.

Some disclosed example grounding brush systems to mitigate electric current in a rotating shaft, and include a plurality of conductive filaments and a conductive coating configured to discharge electrical voltage from a motor shaft to prevent failure due to electrical damage of any bearings in electrical continuity with the motor shaft for at least the L-10 life of the bearings in electrical continuity with the motor shaft. In some examples, the conductive filaments and the conductive coating are configured to prevent failure due to excess current erosion of any bearings in electrical continuity with the motor shaft for at least the L-10 life of the bearings. In some examples, the conductive filaments and the conductive coating are configured to prevent failure due to current leakage erosion of any bearings in electrical continuity with the motor shaft for at least the L-10 life of the bearings.

Disclosed example apparatus to facilitate electrical conductivity between surfaces include: a conductive surface configured to be coupled to a grounding reference; a base oil, comprising a phenyl ether polymer-derived oil, applied to the conductive surface; and a plurality of particulates carried by the base oil, the plurality of particulates configured to increase an electrical conductivity of the base oil to conduct current between the conductive surface and a second surface to be grounded via the conductive surface.

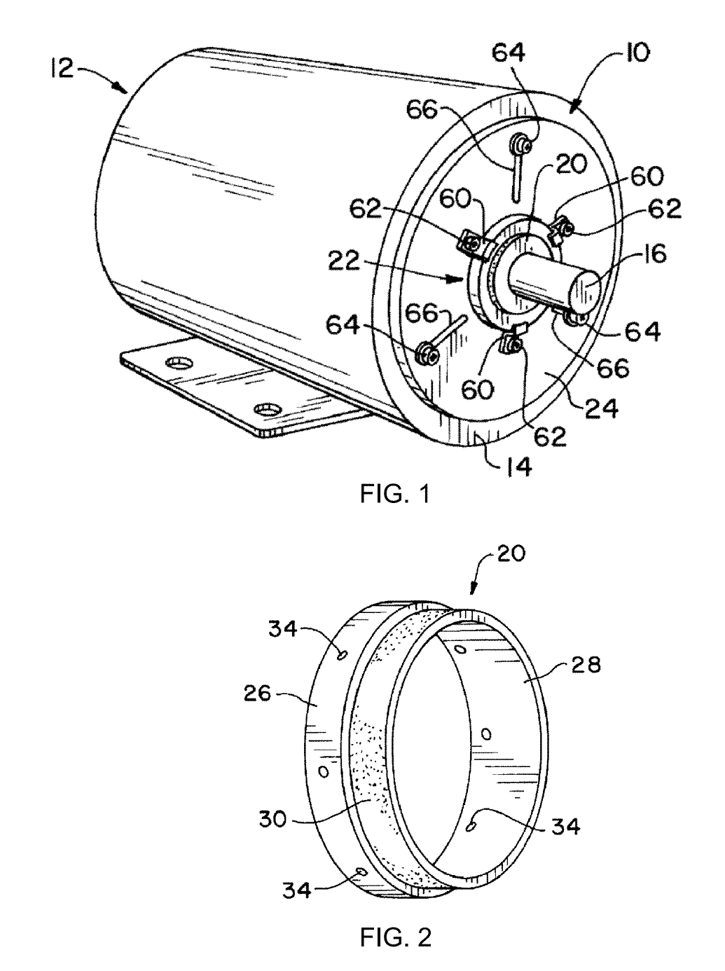

Referring now more specifically to the drawings and to FIG. 1 in particular, a grounding brush system 10 is installed on a motor 12 against a housing faceplate 14 of the motor 12. The example grounding brush system 10 dissipates electrical charges that may build up on a shaft 16 of the motor 12. The grounding brush system 10 can be provided in a variety of different sizes for use in motors of different types and on shafts 16 of different diameters. The grounding brush system 10 can also be used on rotating shafts of turbines, conveyors and other assemblies and constructions that may build up an electrical charge. Use of disclosed examples is not limited to electric motors, and the motor 12 is shown and described only as one suitable and advantageous use.

The example grounding brush system 10 includes a shaft collar 20 and a brush ring assembly 22. The example shaft collar 20 is mounted on and surrounds the shaft 16. The brush ring assembly 22 is secured to motor faceplate 14 via a mounting plate 24. In some examples, the shaft collar 20 is integral to the shaft 16, such that the shaft 16 includes the shaft collar 20. As used herein, a shaft may, but does not necessarily, include a shaft collar, a shaft extension, a shaft stub, a gearbox shaft, and/or any other components that are in electrical continuity with the shaft and are subject to rotational movement. That is, unless otherwise specified, being in electrical contact with the shaft may include electrical contact any of: directly with the shaft 16, with a shaft collar, with a shaft extension, with a shaft stub, with a gearbox shaft, and/or with any other component(s) that are in electrical continuity with the shaft and are subject to rotational movement, whether integral to the shaft 16 or attached to the shaft 16.

The brush ring assembly 22 generally surrounds the shaft 16 and is operatively arranged between the shaft 16 and mounting plate 24 to dissipate, directly or indirectly, through the ground of the motor 12, static charges and/or other charges that build on the motor shaft 16 during operation of the motor 12.

The shaft collar 20 may increase the effectiveness of the grounding brush system 10 for mitigating electrical currents on rotating surfaces. The example collar 20 is made of or coated with highly conductive materials, such as, for example, silver, gold, copper or nickel. Preferably, the materials are both highly conductive and resistant to corrosion and other conductivity deteriorating phenomenon. Alternatively, the collar 20 can be constructed from less expensive conductive materials and/or coated with highly conductive and deterioration resistant materials on the outer surface of the collar 20 in a position to interact electrically with the brush ring assembly 22.

As illustrated in FIG. 2, the example collar 20 includes an anchor ring 26 and a contact ring 28 adjacent the anchor ring 26. The contact ring 28 includes a highly conductive layer 30 of the highly conductive material, such as gold, silver, copper and nickel, for example, disposed on an outer surface of the contact ring 28. The inner diameter of the example collar 20 is configured to engage the outer surface of the shaft 16. Alternatively, collar 20 can be secured to shaft 16 via set screws 32 or the like received in threaded holes 34. The screws 32 establish intimate electrical contact between collar 20 and shaft 16. In other examples, the collar 20 can be of two or more segments clamped against the shaft 16 to provide direct electrical contact of the collar 20 against the shaft 16. In some examples, the highly conductive layer 30 can be provided directly on a surface of a rotating shaft or other moving component to be grounded. For example, conductive inks or paints can be used and applied directly to the surface.

The example collar 20 is secured to the shaft 16 to establish electrical conductivity between the collar 20 and the shaft 16. In retrofit applications, the surface of shaft 16 may be cleaned to remove oxidation, dirt and/or other conductivity-limiting substances. Electrical charge that builds on the shaft 16 during use of the motor 12 is transferred from the shaft 16 to the collar 20 by the direct physical contact established between the shaft 16 and the collar 20, including through the set screws 32, the anchor ring 26 and the contact ring 28 to also build in the layer 30.

While the illustrated examples are shown with the shaft collar 20, examples disclosed herein are also described with reference to the shaft 16, with the understanding that the collar 20 may be omitted or may be considered to be part of the shaft 16. In other words, the grounding brush system 10 may make electrical contact directly with the shaft 16 and/or make electrical contact with the shaft 16 via one or more intermediate layers and/or surfaces.

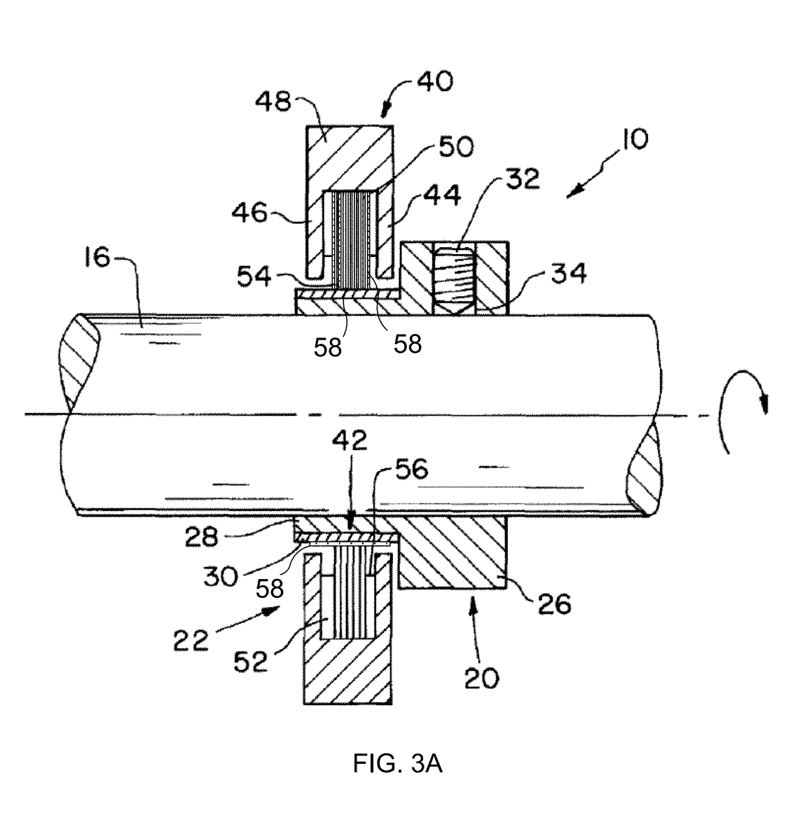

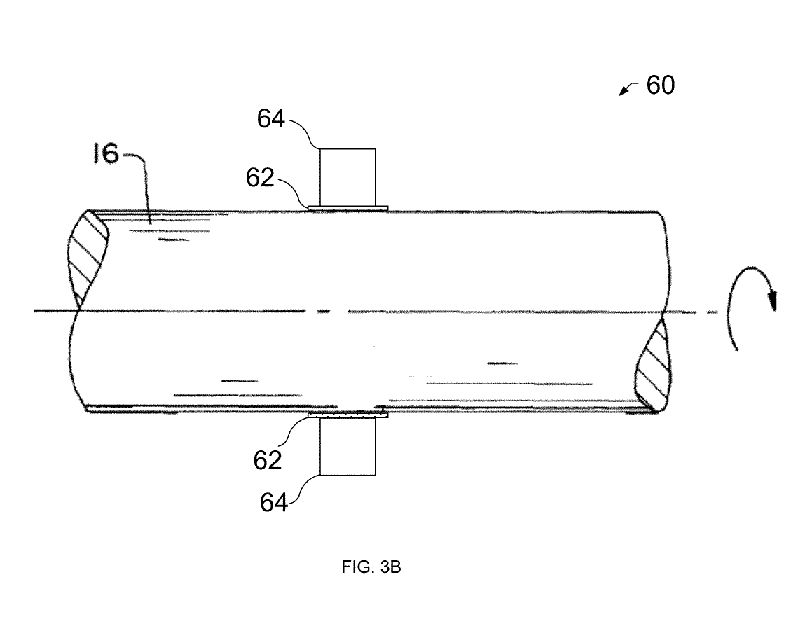

As illustrated in FIG. 3A, the example brush ring assembly 22 includes an annular body 40 and a brush assembly 42 disposed within the annular body 40. The annular body 40 includes an outer segment 44, an inner segment 46 and a base 48. Together, the outer segment 44, the inner segment 46, and the base 48 form an annular channel in which the brush assembly 42 is disposed. The example annular body 40 is made of conductive materials, such as metals including, but not limited to aluminum, stainless steel, bronze and/or copper, and/or conductive plastics.

The example brush assembly 42 includes a plurality of individual fiber-like conductive filaments 50 that may be arranged individually in a substantially continuous annular ring, and/or in a plurality of filament bundles arranged circumferentially around the shaft 16. In some examples, each filament 50 is a fine, hair-like filament made from carbon fibers, nickel, stainless steel, conductive plastics, or any other conductive fiber-type filament. In some such examples, the conductive filaments 50 generally have diameters less than about 150 microns. The conductive filaments 50 may have diameters within a range of about 5 microns to about 100 microns. Alternatively, the conductive filaments 50 can be larger fibers of conductive material that are held in contact with the shaft 16. In some examples, the conductive filaments 50 are integral with the annular body 40, such as by additive manufacturing.

The example conductive filaments 50 are secured within body 40 by an anchor structure 52. The example anchor structure 52 is electrically conductive and may be in the form of clamping structure such as plates between which conductive filaments 50 are held. Alternatively, the anchor structure 52 can be a conductive body of filler material such as conductive plastic, conductive adhesive, or the like, anchoring the conductive filaments 50 in the body 40. Portions of distal ends 54 of the conductive filaments 50 extend past an inner surface 56 of the anchor structure 52 and radially inwardly (relative to the brush assembly and/or the anchor structure 52) of the outer and inner segments 44, 46 toward the shaft 16. The thin, lightweight conductive filaments 50 physically contact the shaft 16 for direct transfer of electrical charge from the shaft 16 without significant wear during operation.

In some other examples, the conductive filaments 50 may be mounted to the shaft 16 (or other rotating surface in electrical continuity with the shaft 16). In such examples, the conductive filaments 50 extend radially outward and/or axially from the shaft 16 to make electrical contact with an external conductor coupled to the electrical ground (or other appropriate electrical discharge point). In some other examples, the conductive filaments 50 are mounted adjacent an end of the shaft 16 (or other rotating surface in electrical continuity with the shaft 16) and oriented at least partially in an axial direction of the shaft 16 (or other rotating surface) to make electrical contact with the shaft 16.

The example conductive filaments 50 completely encircle the shaft 16 and channel shaft voltages to ground. In some examples, the conductive filaments 50 gradually wear to fit the shaft 16 and/or the contact ring 28. When the conductive filaments 50 have worn to fit the shaft 16, the conductive filaments 50 wear rate decreases substantially, and the conductive filaments maintain electrical contact with the motor shaft 16 and/or contact ring 28 via the conductive coating. The conductive coating prevents or substantially reduces corrosion and ensures a highly conductive shaft surface to effectively mitigate shaft voltage.

The example mounting plate 24 is made of electrically conductive material such as metal, including but not limited to aluminum, stainless steel, bronze and copper. The mounting plate 24 also can be made of electrically conductive plastics. In this example, the annular body 40 is held to the mounting plate 24 by clamps 60 and/or screws and/or bolts 62. The example of FIG. 3A includes three clamps 60 with associated screws 62. More or fewer clamps 60 and associated screws 62 can be used, and/or other structure for securing annular body 40 to or against mounting plate 24 also can be used. In some examples, the mounting plate 24 and the annular body 40 can be made as or fabricated to a single body. However, maintaining the mounting plate 24 and the annular body 40 as separate but connected structures allows for disassembly for servicing. For example, the annular body 40 can be removed by releasing the clamps 60 without disconnecting the mounting plate 24 from the motor 12.

The example mounting plate 24 is connected to the motor 12 by a threaded rod or bolt 64 extending axially into and/or through the motor 12. The bolts 64 are received in elongated slots 66 provided in mounting plate 24. The mounting plate 24 may be adjustably positionable relative to the motor 12 and/or can be used on motors of different diameters to receive the bolts 64 positioned at different radial distances from the shaft 16. In the illustrated example, three bolts 64 and associated slots 66 are shown. However, mounting plates 24 of different configurations can be provided so as to accommodate different size and structures for the motor 12.

The example conductive filaments 50 are coated with a conductive coating 58 that enhances the benefits of the conductive filaments 50 for conducting electricity across to the shaft. In the example of FIG. 3A, the conductive coating 58 includes a base fluid and conductive particles configured together to provide a high conductivity to the conductive coating 58 and corrosion protection to the electrically conductive path from the rotating shaft 16. Example conductive particles that may be used to implement the conductive coating may include a powdered metal, such as silver, gold, or a carbon structure, and/or any other powders, flakes, fibrils, short high-aspect ratio fibers, or the like. Example fluids that may be used include oils, into which the conductive particles can be suspended (e.g., substantially uniformly suspended), mixed, and/or dissolved. The base liquid may be an oil such as petroleum, plant, animal, silicone, and/or polymer-derived oil. An example class of oil that may be used to implement the base liquid include phenyl ether polymer-derived oils, such as 5R4E polyphenyl ether. The base oil (e.g., the phenyl ether polymer-derived oil) may be selected based on the environment in which the conductive coating 58 is used (e.g., based on expected and/or potential temperature ranges). In some examples, the base oil 5R4E polyphenyl ether, is selected to prevent migration of the conductive coating away from the interface, even at elevated temperatures. In some examples, the base oil 4R4E polyphenyl ether is selected to accommodate minimal arcing in the shaft grounding device with minimal degradation of the conductive coating over the service life of the grounding device. In some examples, the conductive particles are more than 0 and less than or equal to 50%, by volume, of the conductive coating 58, with the base oil making up the remainder. In some such examples, the conductive particles are between 10% and 50%, by volume, of the conductive coating 58, with the base oil making up the remainder. In some such examples, the conductive particles are between 10% and 40%, by volume, of the conductive coating 58, with the base oil making up the remainder.

The conductive coating 58 improves the conductivity of the grounding brush system 10, increases the current capacity of the grounding brush system 10, decreases the effective impedance of the grounding brush system 10, and decreases the impedance variability from instant to instant and over time. Additionally, the conductive coating 58 may reduce corrosion at the shaft 16 (e.g., leading to improved conductivity over time in challenging environments), reduce susceptibility to conductivity reductions from minor contamination from bearing grease over time, and/or reduce or eliminate the potential for electrical arcing in the bearings, gears, and/or other moving components associated with the motor shaft 10 under normal operating conditions. The example conductive coating 58 may reduce electromagnetic interference (EMI) emissions from devices grounded using the grounding brush system 10 (e.g., reducing radio interference), reduce noise signals for data transmissions, increase the typically already considerable mechanical life of the conductive filaments 50, reduce impedance variability in service, extend the time between service intervals substantially compared to conventional grounding systems, and/or decrease wear particle emissions.

As illustrated in FIG. 3A, the conductive coating 58 can be applied to the entirety of the conductive filaments 58 and/or along a portion of the lengths of the conductive filaments 58, as illustrated on the top half of FIG. 3A. Additionally or alternatively, the conductive coating 58 can be applied to an interface between the conductive filaments 50 and the shaft 16 (e.g., to the tips of the conductive filaments and/or directly to the shaft 16), as illustrated on the bottom half of FIG. 3A. In some examples, the conductive coating 58 is applied to one or more portions of the conductive filaments 50 and/or the shaft 16, the collar 20, and/or other contact surface in electrical continuity with the shaft 16. The conductive coating 58 may then be distributed to other conductive filaments 50 and/or surfaces of the shaft 16 via rotation of the shaft 16 (e.g., by moving the conductive filaments 50 and/or portions of the surface of the shaft 16 that contain the coating into and out of contact with other conductive filaments 50 and/or portions of the surface of the shaft 16).

Transfer of charge from the shaft 16 to the filaments 50 occurs directly by touching contact of the filaments 50 against the shaft 16, and/or indirectly by conduction between the shaft 16 and the filaments 50 via the conductive coating 58. The electrical charge can transfer from the filaments 50 through the body 40 and the mounting plate 24 to the housing faceplate 14 and the ground connection of the motor 12. Thus, charges that build on the shaft 16 are dissipated to ground through grounding brush system 10 before arcing can occur. As used herein, the term “grounding” refers to any circuit path which allows the grounding device to effect a reduction in the voltage difference between the shaft 16 and the motor stator/frame. In disclosed examples, grounding provides effective protection for the motor bearings and/or downstream equipment such as gears, bearings, or the like.

The relationship between and performances of the layer 30 and the conductive filaments 50 can be optimized by selecting materials that function well together for physical contact and direct transfer from the shaft 16 via the conductive coating 58. When present, the collar 20 establishes and maintains good electrical contact with the shaft 16 even if exposed surfaces of the shaft 16 corrode over time, and the properties of the collar 20 and, particularly, the layer 30 maintain a high level of performance by the grounding brush system 10.

The example conductive filaments 50 and the conductive coating 58 protect motor bearings that are in electrical continuity with the shaft 16 from electrical damage for the full L-10 life of such bearings. For example, the conductive filaments 50 may be sufficiently numerous, and the conductive coating 58 may be configured to have sufficient conductivity, to protect any bearings that are in electrical continuity with the shaft 16 from failure due to excess current erosion, as defined in ISO 15243:2017 Section 5.4.2, and/or from failure due to current leakage erosion, as defined in ISO 15243:2017 Section 5.4.3, for at least the L-10 life of the bearings. In other words, the example conductive filaments 50 and the conductive coating 58 may substantially eliminate excess current and/or current leakage erosion as causes of bearing failure. The L-10 life of a bearing refers to the number of hours of service that 90% of the instances of that type of bearing will survive, and varies by application.

While disclosed examples are described above with reference to motor shafts, the conductive filaments 50 and the conductive coating 58 may also be used to make electrical contact within a slip ring for current transfer.

FIG. 3B illustrates another example shaft grounding system 60 including a coating 62 applied between the shaft 16 and a grounding surface 64 in sliding contact with the shaft 16. The example grounding surface 64 is electrically coupled to a grounding reference to provide electrical discharge. In some examples, the grounding surface 64 may be provided with the coating 62, and then installed or otherwise positioned in contact with the motor shaft 16.

The example coating 62 may be similar or identical to any of the example conductive coatings 58 disclosed above (e.g., the combination of base fluid and particulates). The coating 62 may be applied to the shaft 16 and/or the contact surface 64 placed in sliding contact with the shaft 16 (e.g., without the filaments 50). Rotation of the shaft 16 and/or the surface 64 may distribute the coating 62 to portions of the surface 64 and the shaft 16 that are in sliding contact but not coated.

While the example surface 64 is illustrated in FIG. 3B as a ring encircling the shaft 16, in other examples the surface 64 contacts the shaft 16 at less than the entire circumference of the shaft 16, at multiple locations along a length of the shaft 16, and/or at an end of the shaft 16. As mentioned above, contact between the surface 64 and the shaft 16 may include contact with any of a shaft collar, a shaft extension, a shaft stub, a gearbox shaft, and/or any other components that are in electrical continuity with the shaft 16 and subject to rotational movement.

The example coating 62 provides the same or similar advantages and benefits as the grounding brush system 10 of FIG. 3A, including: reduction and/or elimination of VFD-induced shaft voltage; improved motor bearing life; reduced corrosion, rust, contamination, and/or oxidation of the shaft 16; reduced electromagnetic interference, radio frequency interference, and/or signal noise; and/or increased maintenance intervals.

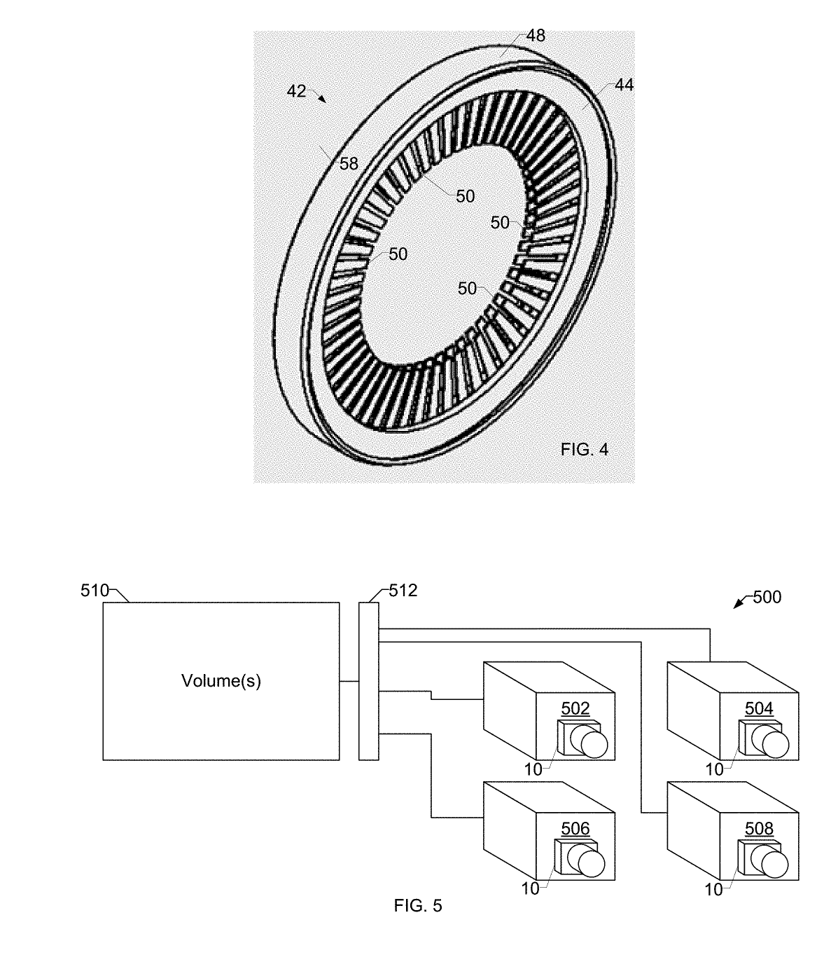

FIG. 4 is a perspective view of the brush assembly 42 of FIG. 3A. As illustrated in FIG. 4, the brush assembly 42 includes the outer segment 44, the inner segment (not visible), the base 48, and the conductive filaments 50 having the conductive coating 58. The example conductive filaments 50 of FIG. 4 may be arranged in groups or uniformly around an inner perimeter 68 of the base 48. The conductive coating 58 may be applied to the contacting tips of the conductive filaments 50, or uniformly along the lengths of the conductive filaments.

The example brush assembly 42 reduces or eliminates the effects of VFD-induced shaft voltage, while mitigating the effects of shaft corrosion, rust, and/or contamination beneath the conductive filaments 50. The conductive filaments and the conductive coating 58 maintain a highly conductive shaft surface and low shaft voltage substantially below the threshold of bearing discharges (e.g., 10 to 40 volts peak under NEMA MG1 part 31.4.4.3).

FIG. 5 is a block diagram of an example fan array system 500 including the grounding brush system of FIGS. 1-4. Fan arrays (or fan walls) uses multiple, smaller fan wheels arranged in parallel airflow paths. Variable frequency drives (VFD) are used to control one or multiple motors on direct-drive plenum fans which are used in the array to provide cooling in a range of applications that provide control of temperature, humidity, and/or airflow. VFDs can induce stray voltages on the shafts of the motors controlled by the VFDs. The induced voltages can discharge through motor bearings, causing pitting (i.e., tiny fusion craters in metal bearing surfaces), frosting (i.e., widespread pitting), fluting (i.e., washboard-like ridges on the bearing race), and/or complete bearing failure.

Due to the challenging temperature and humidity environment of fan arrays, the shaft of motors used in fan arrays are subject to corrosion and rust, which interrupts the operation of any shaft grounding device. Conventional shaft grounding systems provide only limited protection and wear out, or are otherwise hampered by corrosion, quickly. Conventional shaft grounding rings are susceptible to shaft corrosion, which can hamper the effectiveness of the shaft grounding rings by reducing the conductivity of the discharge path from shaft to ground.

The example fan array system 500 includes multiple motors 502, 504, 506, 508 configured to provide parallel airflow paths to one or more volumes 510 via a heat exchanger 512. The example motors 502-508 are equipped with the example brush grounding system 10 of FIGS. 1-4 disclosed herein. The example brush grounding systems 10 mitigate corrosion of the shafts on the motors 502-508 using the conductive coating 58 and the conductive filaments 50. The filaments improve the conductivity and provides effective protection against electrical damage to the fan array motors 502-508 for the full L-10 life of the motor bearings. Furthermore, the brush grounding systems 10 protect the bearings of the motors 502-508 from electrical discharges by maintaining a highly conductive shaft surface in contact with the conductive filaments 50 so that the shaft voltage discharges in the enhanced conductivity shaft grounding ring instead of the bearings of the motors 502-508.

In addition to fan arrays including motors having the example brush grounding systems, other systems that may benefit from providing motors having the example brush grounding systems include: other heating, ventilation, and air conditioning (HVAC) systems; hazardous duty motors (e.g., motors used in environments up to Class I, Division 2 environments using the National Electric Code (NEC) definitions and/or international equivalents); and/or motors in electrically sensitive applications in which a purpose of brush grounding is to reduce electromagnetic interference, radio frequency interference, and/or signal noise, such as electric vehicle applications in which radio transmission is used, such as radar equipment aiming system motors. Additionally or alternatively, disclosed example brush grounding systems may increase the maintenance interval for motors, such as motors in wind turbine power generators.

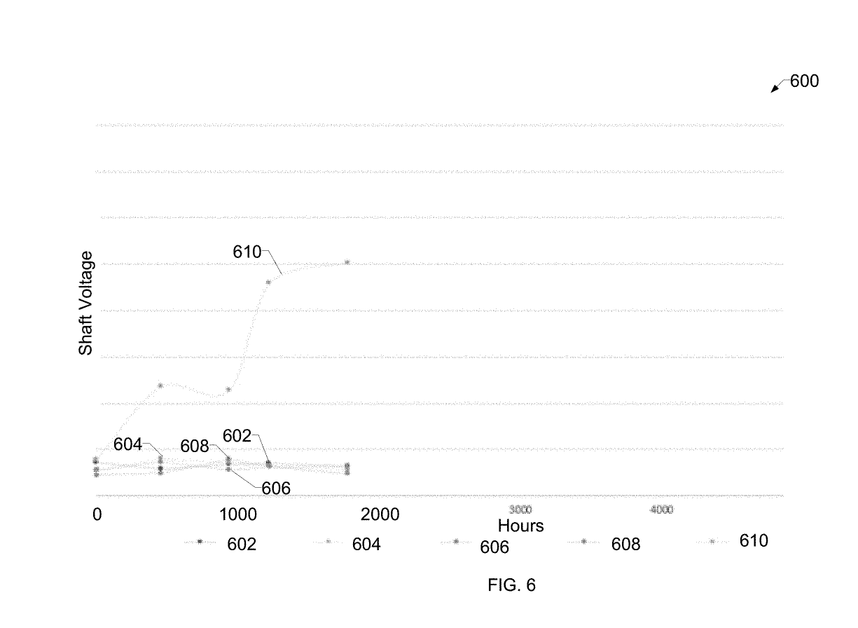

FIG. 6 is a graph 600 illustrating the performance of the example brush grounding systems 10 compared with a conventional shaft voltage mitigation system. Four example brush grounding systems were tested in a fan array application, and traces 602, 604, 606, 608 illustrate the shaft voltage, measured at several times during the test, for the motors equipped with brush grounding systems in accordance with this disclosure. A trace 610 illustrates the shaft voltage measured at the same times for a motor equipped with a conventional voltage mitigation system. As illustrated in FIG. 6, the traces 602-608 demonstrate effective shaft voltage mitigation even when the conventional system loses voltage mitigation performance.

While examples are described above with reference to electric motor shafts, disclosed example grounding brush systems may be used for other applications.

As utilized herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”. As utilized herein, the term “exemplary” means serving as a non-limiting example, instance, or illustration. As utilized herein, the terms “e.g.,” and “for example” set off lists of one or more non-limiting examples, instances, or illustrations.

While the present method and/or system has been described with reference to certain implementations, it will be understood by those skilled in the art that various changes may be made and equivalents may be substituted without departing from the scope of the present disclosure. In addition, many modifications may be made to adapt a particular situation or material to the teachings of the present disclosure without departing from its scope. For example, systems, blocks, and/or other components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

What is claimed is:

1. A grounding brush system to mitigate electric current in a rotating shaft, the grounding brush system comprising:
a brush assembly configured to be disposed proximate a motor shaft, the brush assembly having conductive filaments configured to be in electrical continuity with the motor shaft when the brush assembly is disposed proximate the motor shaft; and
a conductive coating comprising a base liquid and conductive particles, in which the conductive coating coats at least respective portions of the conductive filaments so as to provide an electrical path between the conductive filaments and the motor shaft.

2. The grounding brush system as defined in claim 1, further comprising a collar mounted to the motor shaft, wherein the conductive filaments are in electrical contact with the motor shaft via the collar.

3. The grounding brush system as defined in claim 2, wherein the collar is coated with the conductive coating at least at areas of contact between the collar and the conductive filaments.

4. The grounding brush system as defined in claim 1, wherein the motor shaft is coated with the conductive coating at least at areas of contact between the motor shaft and the conductive filaments.

5. The grounding brush system as defined in claim 1, wherein the conductive particles comprise at least one of a powdered metal or carbon.

6. The grounding brush system as defined in claim 1, wherein the base liquid comprises an oil.

7. The grounding brush system as defined in claim 1, wherein the conductive filaments comprise at least one of carbon fiber, nickel, stainless steel, or a conductive plastic.

8. The grounding brush system as defined in claim 1, wherein the conductive filaments are configured to be in electrical continuity with the motor shaft by at least one of: direct contact with the motor shaft, via a shaft collar, via a shaft extension, via a shaft stub, or via a gearbox.

9. The grounding brush system as defined in claim 1, wherein the brush assembly is configured to be mounted on the motor shaft, and the conductive filaments are configured to extend radially outward from the motor shaft.

10. The grounding brush system as defined in claim 1, wherein the base liquid comprises a phenyl ether polymer-derived oil.

11. The grounding brush system as defined in claim 1, wherein the conductive coating is configured to be distributed to at least a portion of the conductive filaments by rotation of the motor shaft.

12. The grounding brush system as defined in claim 1, wherein the brush assembly is configured to be coupled to an electrical ground to provide an electrical path between the motor shaft and an electrical ground.

13. The grounding brush system as defined in claim 1, wherein the brush assembly is configured to be mounted around the motor shaft, and the conductive filaments are configured to extend radially toward the motor shaft.

14. The grounding brush system as defined in claim 1, wherein the brush assembly is configured to be mounted proximate the motor shaft, and the conductive filaments are configured to extend axially toward the motor shaft.

15. The grounding brush system as defined in claim 1, wherein the conductive filaments and the conductive coating are configured to prevent failure due to excess current erosion of any bearings in electrical continuity with the motor shaft for at least the L-10 life of the bearings.

16. The grounding brush system as defined in claim 1, wherein the conductive filaments and the conductive coating are configured to prevent failure due to current leakage erosion of any bearings in electrical continuity with the motor shaft for at least the L-10 life of the bearings.

17. A grounding brush system to mitigate electric current in a rotating shaft, the grounding brush system comprising a plurality of conductive filaments and a conductive coating configured to discharge electrical voltage from a motor shaft to prevent failure due to electrical damage of any bearings in electrical continuity with the motor shaft for at least the L-10 life of the bearings in electrical continuity with the motor shaft.

18. The grounding brush system as defined in claim 17, wherein the conductive filaments and the conductive coating are configured to prevent failure due to excess current erosion of any bearings in electrical continuity with the motor shaft for at least the L-10 life of the bearings.

19. The grounding brush system as defined in claim 17, wherein the conductive filaments and the conductive coating are configured to prevent failure due to current leakage erosion of any bearings in electrical continuity with the motor shaft for at least the L-10 life of the bearings.

20. An apparatus to facilitate electrical conductivity between surfaces, the apparatus comprising:
a conductive surface configured to be coupled to a grounding reference;
a base oil, comprising a phenyl ether polymer-derived oil, applied to the conductive surface; and
a plurality of particulates carried by the base oil, the plurality of particulates configured to increase an electrical conductivity of the base oil to conduct current between the conductive surface and a second surface to be grounded via the conductive surface.
